(19) United States
(12) Patent Application Publication
(10) Pub. No.: US 2014/0140072 A1
(43) Pub. Date: May 22, 2014

(54) NATURAL MATERIAL APPLIED THREE-DIMENSIONAL PANEL FOR IMPLEMENTING MOOD ILLUMINATION AND METHOD FOR MANUFACTURING THREE-DIMENSIONAL PANEL

(71) Applicant: HYUNDAI MOTOR COMPANY, Seoul (KR)

(72) Inventors: Han Ki Lee, Hwaseong (KR); Kie Youn Jeong, Hwaseong (KR)

(73) Assignee: HYUNDAI MOTOR COMPANY, Seoul (KR)

(21) Appl. No.: 13/764,000

(22) Filed: Feb. 11, 2013

(30) Foreign Application Priority Data
Nov. 16, 2012 (KR) 10-2012-0129908

(51) Int. Cl. F21V 11/00; B32B 38/10

(52) U.S. Cl. CPC F21V 11/00; B32B 38/10
USPC 362/355; 156/222

(57) ABSTRACT

Disclosed herein are a natural material applied three-dimensional (3D) panel for providing mood illumination and a method for manufacturing the 3D panel, in which press processing is used and a transparent material is applied on a top side of a natural material. Thus, moldability and reliability of a part to be molded is increased.

### CROSS-REFERENCE TO RELATED APPLICATION

This application claims under 35 U.S.C. §119(a) the benefit of Korean Patent Application No. 10-2012-0129908 filed on Nov. 16, 2012, the entire contents of which are incorporated herein by reference.

### BACKGROUND

(a) Technical Field

The present disclosure relates to a three-dimensional (3D) panel having a natural material applied thereto to implement mood illumination in which a natural material and a diffusion layer are applied simultaneously to the 3D panel to provide a sense of material depth and mood illumination, and a method for manufacturing the 3D panel.

(b) Background Art

Generally, resin mold parts have been widely used as interior and exterior materials of vehicles in console boxes or panels near dashboards of the vehicles, and also in electronic consumer appliances such as cases or covers of rice cookers or the like.

In particular, various controllers are installed in dashboards and audio decks, gear transmission units, airbags, door locks, and window opening/closing units which are mounted near a front seat in the vehicle, forming a gap between an exterior material and an interior material of various controllers. Furthermore, an interior material finish panel is installed for the aesthetic appearance of the interior of the vehicle. Thus, since the vehicle finish panel has an influence on the aesthetic appearance of the interior of a vehicle, demand for an appearing aesthetic appearance of the interior of the vehicle is increasing. Additionally, the demand for interior materials using various real materials (e.g., natural materials) such as real wood, real aluminum, carbon woven film, and mother of pearl is increasing.

However, when natural materials are used, the following problems may occur.

First, conventional natural material applied parts have constraints in molding methods and available materials due to insufficient moldability and reliability of the natural materials.

Second, the conventional natural material applied parts provide a sense of material depth and appearance clarity (e.g., capability of producing natural imprints of a subject without distortion) via clear layer coating, polyurethane reaction injection, dual injection, or the like. In clear coating, the surface has low quality, and in PUR casting, the appearance of the surface may be improved, but the process involves complex processing and high cost. Dual injection is favorable to mass production, but the process may cause excessive pattern damages in the molding process.

### SUMMARY

Accordingly, the present invention provides a natural material applied three-dimensional (3D) panel for providing mood illumination and a method for manufacturing the 3D panel, in which press processing is used, thereby increasing moldability and reliability, and a natural material (e.g., a pattern layer) and a diffusion layer are applied simultaneously, thus improving the appearance of the surface, and a sense of material depth by adjusting the thickness of a transparent layer.

According to an aspect of the present invention, the 3D panel may include a diffusion layer configured to provide surface light emission for light source concealment during illumination of a light source, a natural material stacked on the diffusion layer to provide a unique material surface texture, and a transparent sheet stacked on a top side of the natural material to protect the natural material and provide a sense of material surface depth.

The 3D panel may further include a polyurethane (PU) sheet stacked between the diffusion layer and the natural material, wherein the PU sheet may be dipped into the natural material by heat to improve adherence with the transparent layer and increase moldability of the part.

A thickness of the transparent sheet may be adjusted to about 0.5-5 mm to provide a sense of material depth. Additionally, the diffusion layer may use the same material as the transparent sheet to maintain the same shrink rate as the transparent sheet and to maintain the shape of the part by preventing the part from curling.

Furthermore, the present invention provides a method for manufacturing a natural material applied three-dimensional (3D) panel to provide mood illumination, the method including stacking a diffusion layer configured to provide surface light emission during illumination of a light source under a natural material configured to provide a unique material surface texture, adhering a transparent sheet to the natural material to protect the natural material and provide a sense of material surface depth, stacking a polyurethane (PU) sheet on a rear side of the natural material to improve adherence with the transparent layer and increasing moldability of a part to be molded, inserting the stacked sheets into a press mold; performing a hot press molding at a temperature of about 110-150° C.; and trimming the molded part via punching press at the hot press molding.

### BRIEF DESCRIPTION OF THE DRAWINGS

The above and other features of the present invention will now be described in detail with reference to an exemplary embodiment thereof illustrated the accompanying drawings which are given hereinbelow by way of illustration only, and thus are not limitative of the present invention, and wherein:

FIG. 1 is an exemplary diagram illustrating a structure of a natural material applied three-dimensional (3D) panel for mood illumination according to an exemplary embodiment of the present invention; and

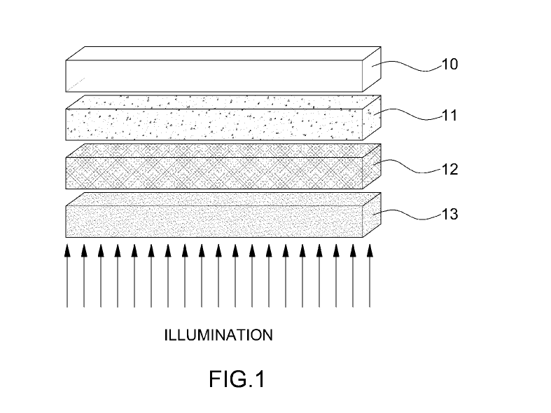

FIG. 2 is an exemplary processing diagram illustrating a method for manufacturing a natural material applied 3D panel according to an exemplary embodiment of the present invention.

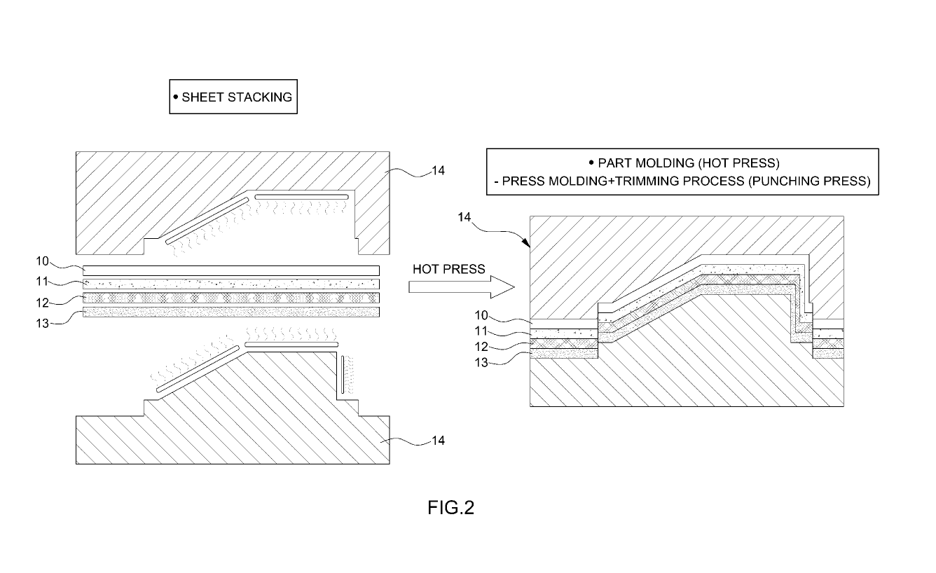

### DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described in detail with reference to the accompanying drawings to allow those of ordinary skill in the art to easily carry out the present invention.

The preset invention relates to a three-dimensional (3D) panel to which a natural material 11 is applied to form a unique surface texture of the natural material 11 and to provide surface light emission for light source concealment when illumination from a light source is applied. The 3D panel may include a transparent sheet 10, the natural material 11, a polyurethane (PU) sheet 12, and a diffusion layer 13.

Furthermore, the transparent sheet 10 (e.g., transparent layer) may include an ester based transparent material such as polyethylene terephthalate (PETG), polycarbonate (PC), polymethyl methacrylate (PMMA), or the like as a chemical resistant and light resistant material, and may protect the natural material 11 and provide a sense of material surface depth. The natural material 11 may form a unique surface texture. The PU sheet 12 (e.g., PU layer) may be applied to a rear side of the natural material 11, and in press processing, the PU sheet 12 may be melted by heat and dipped into a layer of the natural material 11 to adhere the natural material 11 to the transparent sheet 10, thereby increasing moldability of the natural material 11 part to be molded. The diffusion layer 13 may provide surface light emission for light source concealment during illumination of a light source, and may use a diffusing agent of the same material as the transparent sheet 10 to maintain the same shrink rate as the transparent sheet 10 (e.g., the surface layer), thereby maintaining the part shape by preventing curling (in which the part is rolled in a round shape).

The components of the 3D panel will be described in more detail.

1. Transparent Layer 10 (e.g., PETG, PC, PMMA)

The transparent layer 10 may be disposed on the surface of the 3D panel and may be manufactured as a top board of a three-layer structure panel. Furthermore, the transparent layer 10 on a front side of the natural material 11 may be manufactured as the transparent sheet 10, and press molding may be performed to mold a part. In the press molding process, the sense of depth of the surface of the natural material 11 may be increased by adjusting the material thickness.

The thickness of the transparent layer 10 may be about 0.5-5 mm. When the thickness of the transparent layer 10 is less than about 0.5 mm, the flow of the material may decrease, causing the natural material 11 to move or tear during press molding, and the aesthetic appearance of the part may decrease due to insufficient depth sense of the material. Additionally, when the thickness of the transparent layer 10 is greater than about 5 mm, a cooling time after molding increases due to the increased thickness, decreasing productivity and causing sink mark corresponding to shrinkage. Therefore, it is preferable that the thickness of the transparent layer 10 be 0.5-5 mm.

Furthermore, the transparent layer 10 may use an ester based transparent material such as PETG, PC, PMMA, or the like, and may have a transmissivity of 90% or higher. In addition, the transparent layer 10 on the front side of the natural material 11 may be used as a non-coated material, and therefore, a material exhibiting surface reliability, in other words, light resistance, scratch resistance, heat resistant cycle, moisture resistance, heat resistance, and chemical resistance may be used for the transparent layer 10.

2. Natural Material 11

The natural material 11 may be used to provide a variety of colors, surface textures, and patterns, and may be dipped between the transparent layer 10 and the diffusion layer 13 to prevent deformation, such as, cracks or movement of the natural parts during press molding.

When layer separation occurs due to insufficient adherence between the transparent layer 10 and the natural material 11, an ester based nonwoven fabric may be used to improve adherence. Furthermore, the natural material 11 may be real wood, real carbon, or the like, and may alternatively be a light transmitting material to provide mood illumination or use materials such as branches, leaves, films, wallpapers, and woven fabrics (e.g., fabrics).

3. PU Sheet 12

The PU sheet 12 may be used to secure adherence between the transparent layer 10 and the natural material 11 and between the natural material 11 and the diffusion layer 13 and may increase the moldability of a part to be molded. The PU sheet 12 may be disposed on the rear side of the natural material 11 (e.g., a pattern layer) and may be dipped into the natural material 11 by heat during press processing, thereby improving adherence with the transparent layer 10 and increasing moldability of the part.

4. Diffusion Layer 13

The diffusion layer 13 may be applied to the natural material 11 to provide light source concealment and surface light emission, and may use an ester based material such as PETG (ECOZEN), PC, or PMMA similar to the transparent layer 10. In addition, to maintain the same shrink rate as the upper transparent layer 10, the same material as the transparent layer 10 may be used for the diffusion layer 13.

The diffusion layer 13 may use both a diffusing agent added type and a diffusion type based on surface processing. Furthermore, the diffusion layer 13 may include a light source (e.g., a point light emitting light source) such as a light emission diode (LED) mounted therein to conceal the light source, and may diffuse point light emission from the light source to provide surface light emission.

A description will be made of a method for manufacturing the foregoing natural material applied 3D panel for providing mood illumination.

The 3D panel may be manufactured in a multi-layer structure including three or more layers by stacking a transparent layer 10, a natural material 11, a PU sheet 12, and a diffusion layer 13.

The transparent layer 10 may use a material having a transmissivity of about 90% or higher, and the thickness thereof may be adjusted to about 0.5-5 mm. In addition, the transparent layer 10 and the diffusion layer 13 may use an ester based transparent material having high chemical resistance, light resistance, and scratch resistance.

To maintain inter-layer adherence, the PU sheet 12 may be stacked on a rear side of the natural material 11 (e.g., a pattern layer) by dipping the PU sheet 12 into the natural material 11 by heat of press processing, thereby improving adherence with the transparent layer 10 and increasing the moldability of the part to be molded.

In addition, the stacked 3D panel may be inserted into a press mold 14 for press molding. The press molding process may include a hot press molding in a temperature range of about 110-150° C., in which a raw material may be inserted into a mold and heated by a heating source included in the mold for press molding. When the molding operation is performed in a condition out of the temperature range, unevenness and air bubbles may be generated, causing appearance defects after molding.

In press molding, the mold 14 may have a flat surface or a curved surface, and when the mold is applied to the natural material 11 having no flexibility, the pattern layer may be damaged. Thus, the curved surface may correspond to the type of natural material 11 within a predetermined limit preventing defects such as crack, movement of the natural material during processing, and the like

Moreover, upon completion of press molding the part may be trimmed. The trimming of the 3D panel may be performed considering the shape of the product and exterior surfaces. In particular, the part may be trimmed by using a punching press process at a high temperature during hot press processing.

Therefore, according to the present invention, by applying press processing as an alternative to the conventional coating, PUR casting, and polishing, the process may be simplified, thus reducing the cost and diversifying available pattern materials.

In addition, the transparent material may be stacked on the top board of the panel and press processing may be performed to provide a sense of material depth, thereby increasing the sense of material depth based on a thickness adjustment of the surface layer.

Moreover, the diffusion layer 13 may be applied under the natural material 11, to provide surface light emission and to allow the light illumination to be adjusted through the diffusion layer 13, and the impression of colors and a mood may be adjusted through the natural material 11, thereby providing mood illumination.

Furthermore, the PU sheet 12 may be stacked under the natural material 11, to melt the PU sheet 12 during a hot press molding and dip the PU sheet 12 into the natural material 11, thereby improving inter-layer adherence and moldability of the part, moisture resistance, and freezing resistance.

Description of Reference Numerals

| | |
|---|---|
| 10: Transparent Sheet | 11: Natural Material |
| (Transparent Layer) | (Pattern Layer) |
| 12: PU Sheet | 13: Diffusion Layer |
| 14: Press Mold | |

What is claimed is:

1. A natural material applied three-dimensional (3D) panel for providing mood illumination, the 3D panel comprising:
a diffusion layer configured to provide surface light emission for light source concealment during illumination of a light source;
a natural material stacked on the diffusion layer to provide a unique material surface texture; and
a transparent sheet stacked on a top side of the natural material to protect the natural material and provide a sense of material surface depth.

2. The 3D panel of claim 1, further comprising:
a polyurethane (PU) sheet stacked between the diffusion layer and the natural material and dipped into the natural material by heat to improve adherence with the transparent layer and increase part moldability.

3. The 3D panel of claim 1, wherein a thickness of the transparent sheet is adjusted to about 0.5-5 mm to provide the sense of material surface depth.

4. The 3D panel of claim 1, wherein the diffusion layer uses the same material as the transparent sheet to maintain the same shrink rate as the transparent sheet and to prevent curling of a part to be molded.

5. The 3D panel of claim 1, wherein the diffusion layer and the transparent sheet includes an ester based transparent material selected from a group consisting of: polyethylene terephthalate, polycarbonate, and polymethyl methacrylate.

6. The 3D panel of claim 1, wherein the natural material is selected from a group consisting of: a real wood, a real carbon, a plurality of leaves, a film, a wallpaper, and a woven fabric.

7. A method for manufacturing a natural material applied three-dimensional (3D) panel to provide mood illumination, the method comprising:
stacking a diffusion layer configured to provide surface light emission, a natural material configured to provide a unique material surface texture, a transparent sheet configured to protect the natural material and provide a sense of material surface depth, and a polyurethane (PU) sheet configured to improve adherence with the transparent layer and increase part moldability;
inserting the stacked sheets into a press mold;
performing a hot press molding of the stacked sheets at a temperature of about 110-150° C.; and
trimming a molded part using a punching press process during the hot press molding.
